(19) United States
(12) Patent Application Publication
(10) Pub. No.: US 2017/0147904 A1
(43) Pub. Date: May 25, 2017

(54) PICTURE PROCESSING METHOD AND APPARATUS

(71) Applicant: TENCENT TECHNOLOGY (SHENZHEN) COMPANY LIMITED, Shenzhen (CN)

(72) Inventors: Linlin ZHONG, Shenzhen (CN); Lang YANG, Shenzhen (CN)

(21) Appl. No.: 15/427,212

(22) Filed: Feb. 8, 2017

Related U.S. Application Data
(63) Continuation of application No. PCT/CN2016/077375, filed on Mar. 25, 2016.

(30) Foreign Application Priority Data
Apr. 29, 2015 (CN) 201510213616.1

(51) Int. Cl. G06K 9/62; G06F 3/0488; G06F 17/30; G06F 3/0484

(52) U.S. Cl. CPC G06K 9/6218; G06K 9/6214; G06F 3/04842; G06F 3/0488; G06F 17/3028; G06F 17/30265

(57) ABSTRACT

The present disclosure provides a picture processing method and apparatus and belongs to the field of information technologies. The method includes: scanning pictures under a picture directory; generating at least one similar picture group according to attribute information of each scanned picture; acquiring one representative picture from each similar picture group according to attribute information of each picture included in each similar picture group; and displaying a representative picture in each similar picture group and other pictures in the each similar picture group with different markings when the at least one similar picture group is displayed. In the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

### RELATED APPLICATION

This application is a continuation of PCT Application No. PCT/CN2016/077375, filed on Mar. 25, 2016, which claims priority to Chinese Patent Application No. 201510213616.1, entitled “PICTURE PROCESSING METHOD AND APPARATUS,” filed on Apr. 29, 2015, which is incorporated by reference in its entirety.

### FIELD OF THE TECHNOLOGY

The present disclosure relates to the field of information technologies, and in particular, to a picture processing method and apparatus.

### BACKGROUND OF THE DISCLOSURE

To obtain a high quality picture, when using a terminal to take pictures or uses a screenshot tool in a terminal to capture a picture, a user usually captures a same content for multiple times to obtain multiple pictures. Because each picture has a certain size, if these pictures are all stored in the terminal, memory of the terminal is consumed, influencing performances of the terminal. Therefore, these pictures usually need to be processed.

In the existing technology, when these pictures are processed, the user often uses naked eyes to identify pictures having similar contents from a picture directory of the terminal. The user selects, from the exhibited pictures, a picture that needs to be saved.

Because all identified pictures are exhibited at the same time, a user can determine which pictures are relatively similar only after checking picture contents. In addition, if the user needs to select one picture from multiple exhibited similar pictures for saving, the user needs to check the pictures one by one and compares the pictures repeatedly. The process is not only inconvenient but also takes a relatively long time.

### SUMMARY

To solve a relevant technical problem, embodiments of the present disclosure provide a picture processing method and apparatus. The technical solutions are as follows:

A first aspect provides a picture processing method. The method includes: scanning pictures under a picture directory; generating at least one similar picture group according to attribute information of each scanned picture, each similar picture group of the at least one similar picture group including at least two pictures, and the attribute information including at least a saving moment and a pixel value; acquiring one representative picture from the each similar picture group according to attribute information of each picture included in the each similar picture group; and displaying a representative picture in the each similar picture group and pictures other than the representative picture in the each similar picture group with different markings when the at least one similar picture group is displayed.

A second aspect provides a picture processing method. The method includes: displaying a picture processing page, the picture processing page including at least a similar picture cleanup option; displaying at least one similar picture group after a selection operation for the similar picture cleanup option is detected, the at least one similar picture group being generated according to attribute information of a picture stored locally, and the attribute information including at least a saving moment and a pixel value; and displaying a representative picture in each similar picture group and pictures other than the representative picture in the each similar picture group with different markings when the at least one similar picture group is displayed.

A third aspect provides a picture processing apparatus. The apparatus includes: a scanning module, configured to scan pictures under a picture directory; a generation module, configured to generate at least one similar picture group according to attribute information of each scanned picture, each similar picture group of the at least one similar picture group including at least two pictures, and the attribute information including at least a saving moment and a pixel value; an acquiring module, configured to acquire one representative picture from the each similar picture group according to attribute information of each picture included in the each similar picture group; and a first display module, configured to display a representative picture in the each similar picture group and pictures other than the representative picture in the each similar picture group with different markings when the at least one similar picture group is displayed.

A fourth aspect provides a picture processing apparatus. The apparatus includes: a first display module, configured to display a picture processing page, the picture processing page including at least a similar picture cleanup option; a second display module, configured to display at least one similar picture group after a selection operation for the similar picture cleanup option is detected, the at least one similar picture group being generated according to attribute information of a picture stored locally, and the attribute information including at least a saving moment and a pixel value; and a third display module, configured to display a representative picture in each similar picture group and pictures other than the representative picture in the each similar picture group with different markings when the at least one similar picture group is displayed.

Beneficial effects brought by the technical solutions provided in the embodiments of the present disclosure include a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

### BRIEF DESCRIPTION OF THE DRAWINGS

To more dearly describe the technical solution in embodiments of the present disclosure, accompanying drawings needed to be used in description for embodiments are briefly described below. Obviously, accompanying drawings in the following description are merely some embodiments of the present disclosure. A person skilled in the art can obtain other drawings according to these accompanying drawings without involving any creative effort.

FIG. 1 is a flowchart of a picture processing method according to an embodiment of the present disclosure;

FIG. 2 is a flowchart of a picture processing method according to another embodiment of the present disclosure;

FIG. 3 is a flowchart of a picture processing method according to another embodiment of the present disclosure;

FIG. 4 is a schematic diagram of a picture processing page according to another embodiment of the present disclosure;

FIG. 5 is a schematic diagram of a similar picture group according to another embodiment of the present disclosure;

FIG. 6 is a schematic diagram of a similar picture group according to another embodiment of the present disclosure;

FIG. 7 is a schematic diagram of a similar picture group according to another embodiment of the present disclosure;

FIG. 8 is a schematic structural diagram of a picture processing apparatus according to another embodiment of the present disclosure;

FIG. 9 is a schematic structural diagram of a picture processing apparatus according to another embodiment of the present disclosure; and

FIG. 10 is a schematic structural diagram of a picture processing apparatus according to another embodiment of the present disclosure.

### DESCRIPTION OF EMBODIMENTS

To make an objective, a technical solution, and advantages of the present disclosure clearer, implementation manners of the present disclosure are further described in detail below with reference to the accompanying drawings.

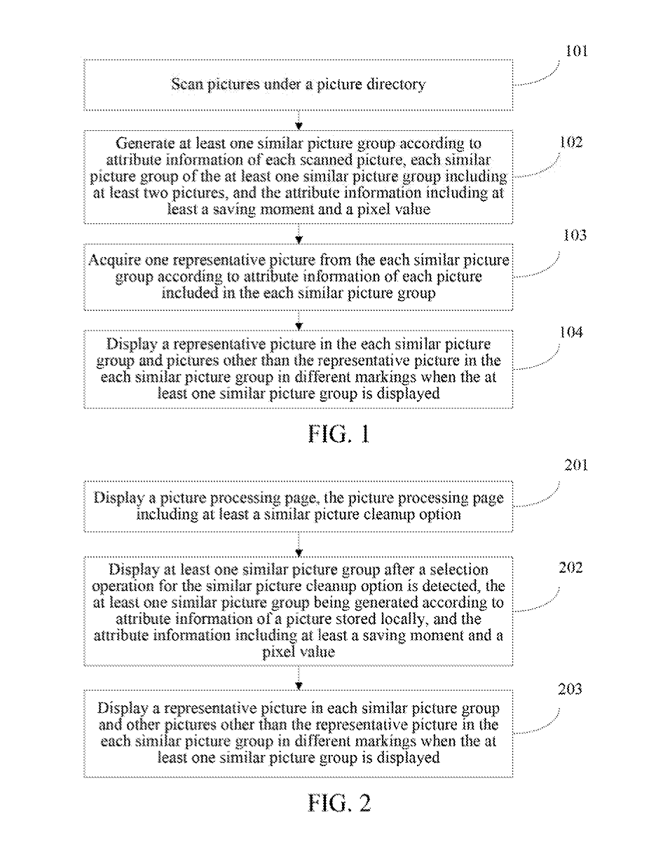

In real life, a user usually takes photos of the same content for multiple times or uses a screenshot tool to capture a same image for multiple times, to acquire a picture that the user is satisfied with. In this process, large quantities of similar pictures are usually generated. If these pictures are stored in a terminal at the same time, memory of the terminal is consumed, influencing performances of the terminal and bringing great inconvenience to the user. Therefore, an embodiment of the present disclosure provides a picture processing method. The method may automatically identify similar pictures for a user and select one picture from the multiple similar pictures and recommend the picture to the user for saving. Referring to FIG. 1, a method process provided in this embodiment includes the following steps.

101: Scan pictures under a picture directory.

102: Generate at least one similar picture group according to attribute information of each scanned picture, each similar picture group of the at least one similar picture group including at least two pictures, and the attribute information including at least a saving moment and a pixel value.

103: Acquire one representative picture from the each similar picture group according to attribute information of each picture included in the each similar picture group.

104: Display a representative picture in the each similar picture group and pictures other than the representative picture in the each similar picture group with different markings when the at least one similar picture group is displayed.

In the method provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

In another embodiment of the present disclosure, the acquiring one representative picture from the each similar picture group according to attribute information of each picture included in the each similar picture group includes determining a picture with an earliest saving moment in the each similar picture group according to a saving moment of each picture included in the each similar picture group and using the determined picture as a representative picture of a similar picture group in which the picture is; determining a picture with a latest saving moment in the each similar picture group according to a saving moment of each picture included in the each similar picture group and using the determined picture as a representative picture of a similar picture group in which the picture is; or determining a picture with a highest pixel value in the each similar picture group according to a pixel value of each picture included in the each similar picture group and using the determined picture as a representative picture of a similar picture group in which the picture is.

In another embodiment of the present disclosure, after the displaying a representative picture in the each similar picture group and pictures other than the representative picture in the each similar picture group with different markings, the method further includes: displaying a save option on the representative picture of the each similar picture group; and saving the representative picture and deleting other pictures within a similar picture group in which the representative picture is if it is detected that a save option on any representative picture is selected.

In another embodiment of the present disclosure, the generating at least one similar picture group according to attribute information of each scanned picture includes: dividing each scanned picture into at least one picture group according, to a saving moment of the each scanned picture, where each picture group of the at least one picture group includes at least two pictures; acquiring a grayscale eigenvalue of each picture included in the each picture group according to a pixel value of the each picture included in the each picture group; acquiring a Hamming distance between grayscale eigenvalues of any two pictures within the each picture group according to a grayscale eigenvalue of each picture included in the each picture group; using any two pictures within the each picture group as similar pictures if the Hamming distance between the grayscale eigenvalues of the any two pictures within the each picture group is less than a preset value; and composing all pictures that are similar pictures to a same picture within the each picture group into a similar picture group.

In another embodiment of the present disclosure, the method further includes: if Hamming distances between a grayscale eigenvalue of one picture within any picture group and grayscale eigenvalues of pictures other than the picture within the picture group are all greater than the preset value, adding the picture to a next picture group and/or a previous picture group, where the next picture group is a picture group whose saving moment is earliest to the picture group, and the previous picture group is a picture group whose saving moment is latest to the picture group.

All the foregoing optional technical solutions may be combined it manners to form optional embodiments of the present disclosure and details are not described herein,

An embodiment of the present disclosure provides a picture processing method. Referring to FIG. 2, a method process provided in this embodiment includes:

201: Display a picture processing page, the picture processing page including at least a similar picture cleanup option.

202: Display at least one similar picture group after a selection operation for the similar picture cleanup option is detected, the at least one similar picture group being generated according to attribute information of a picture stored locally, and the attribute information including at least a saving moment and a pixel value.

203: Display a representative picture in each similar picture group of the at least one similar picture group and pictures other than the representative picture in the each similar picture group with different markings when the at least one similar picture group is displayed.

In the method provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

In another embodiment of the present disclosure, before the displaying a representative picture in each similar picture group of the at least one similar picture group and pictures other than the representative picture in the each similar picture group with different markings, the method further includes; acquiring a representative picture of each similar picture group of the at least one similar picture group, where the representative picture of the each picture group is a picture with an earliest saving moment, a latest saving moment, or a highest pixel value in the each similar picture group.

In another, embodiment of the present disclosure, after the displaying a representative, picture in each similar picture group of the at least one similar picture group and pictures other than the representative picture in the each similar picture group with different markings, the method further includes: displaying a save option on the representative picture of the each similar picture group; and saving the representative picture and deleting other pictures within a similar picture group in which the representative picture is after a selection operation for a save option on any representative picture is detected.

In another embodiment of the present disclosure, before the displaying at least one similar picture group, the method further includes: acquiring at least one similar picture group, where the at least one similar picture group is composed of all pictures that are similar pictures to a same picture within each picture group obtained by performing division according to a saving moment of a picture stored locally, and the similar pictures are pictures that are within the picture group determined according to a pixel value and a Hamming distance between grayscale eigenvalues of which is less than a preset value.

In another embodiment of the present disclosure, the method further includes: adding a picture within any picture group to a next picture group, where the picture is a picture that is in the picture group and a Hamming distance between a grayscale eigenvalue of which and grayscale eigenvalues of pictures other than the picture in the picture group is greater than the preset value, and the next picture group is a picture group whose saving moment is earliest to the picture group.

All the foregoing optional technical solutions may be randomly combined to form optional embodiments of the present disclosure and details are not described herein.

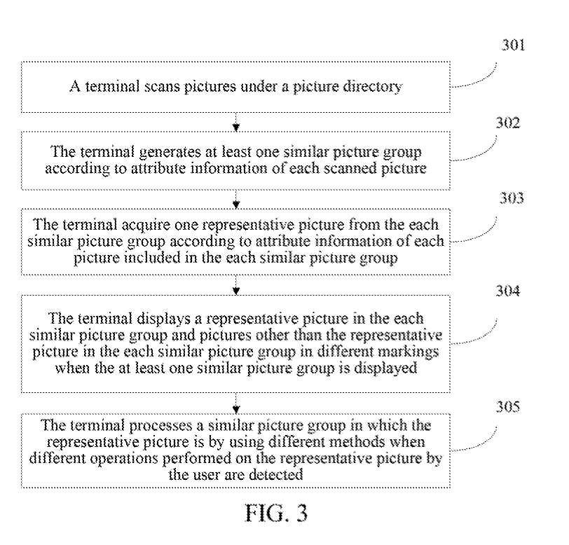

An embodiment of the present disclosure provides a picture processing method. Referring to FIG. 3, a method process provided in this embodiment includes the following steps.

301: A terminal scans pictures under a picture directory.

The terminal may be a smart phone, a tablet computer, a desktop computer, and the like. Product types of the terminal are not specifically limited in this embodiment. In an embodiment oldie present disclosure, a camera may be installed in the terminal, and the terminal may take various pictures based on the installed camera. In another embodiment of the present disclosure, a screenshot application for capturing pictures is installed in the terminal. The terminal can capture, based on the installed screenshot application, a particular area or a whole area on a screen to be saved as a picture.

In this embodiment, the picture directory is a specific directory used for storing pictures in the terminal. Pictures under the picture directory may be pictures taken by using the camera, may be pictures captured by using a screenshot tool, may be pictures downloaded by connecting to a network, or may be pictures received from other terminals other than the terminal by enabling functions such as Bluetooth and infrared. Forms of pictures under the picture directory are not specifically limited in this embodiment.

When scanning pictures under the picture directory, the terminal may preset a scanning order and scans pictures under the picture directory one by one according to the scanning order. The preset scanning order may be a saving moment of a picture, a size of a picture, a type of a picture, and the like. Using an example in which the scanning order is a saving moment, when scanning pictures under the picture directory, the terminal may perform scanning according to saving moments from the latest to the earliest. Specifically, the terminal may first scan a picture with a latest saving moment and then scan a picture with an earliest saving moment. Alternatively, the terminal may perform scanning according to saving moments from the earliest to the latest. Specifically, the terminal may first scan a picture with an earliest saving moment and then scan a picture with a latest saving moment.

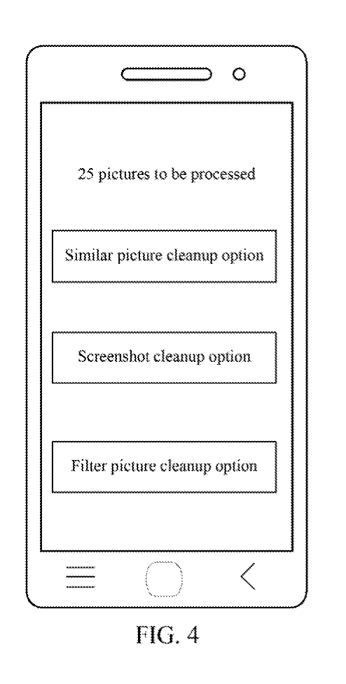

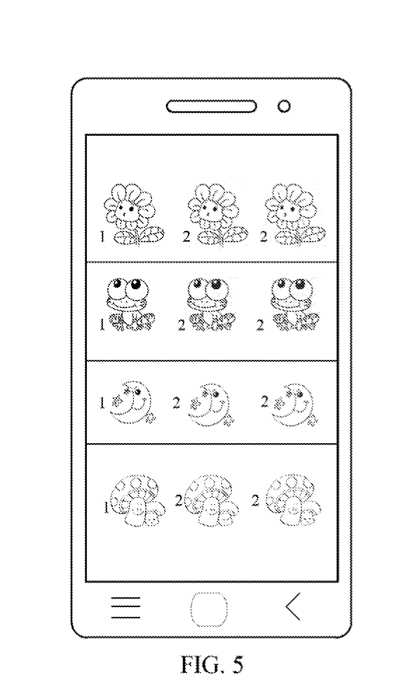

After all pictures under the picture directory are completely scanned, the terminal displays a scanning result on a picture processing page. Referring to FIG. 4, multiple options including a similar picture cleanup option, a screenshot cleanup option, and a filter picture cleanup option are displayed on the picture processing page.

The user may select the similar picture cleanup option, to trigger the terminal to process the scanned pictures. That is, after the terminal detects a selection operation for the similar picture cleanup option, perform step 302.

302: The terminal generates at least one similar picture group according to attribute information of each scanned picture.

In this embodiment, in a process for scanning pictures under the picture directory, the terminal may acquire attribute information of each picture. For example, the attribute information may be a saving moment, a photographing location, a pixel value, brightness, contrast, and a grayscale, and the like of a picture. It is found during research on a large quantity of pictures that similar pictures usually have similar attribute information, and attribute information of dissimilar pictures is usually greatly different. Based on this reason, on a picture processing page, when a selection operation for the similar picture cleanup option is detected, the terminal may generate at least one similar picture group according to attribute information of each picture.

Based on the acquired attribute information of each picture, the terminal generates at least one similar picture group.

When generating at least one similar picture group according to attribute information of each picture, the terminal may use the following steps (1) to (4):

(1) The terminal divides all pictures into at least one picture group according to a saving moment of each scanned picture.

Generally, similar pictures generated in the terminal are all generated when the user takes photos of the same content for multiple times within a particular time period or captures a same area on a screen for multiple times within a particular time period by using a screenshot tool. That is, similar pictures are usually generated within a same time period. Based on the foregoing content, in this embodiment, pictures under the picture directory may be roughly divided into at least one picture group according to a saving moment of each picture, and each picture group of the at least one picture group includes at least two pictures.

In specific implementations, the terminal may preset multiple time intervals and use pictures within a same time interval as one picture group according to the set time interval. For example, the set time interval is five minutes. Then, the terminal uses, by using a picture with a latest saving moment as a starting point, pictures whose saving moments are less than five minutes to a saving moment of the picture as one picture group, and then determines, by using a picture whose saving moment is greater than five minutes to the saving moment of the picture and that has an earliest saving moment as a starting point, pictures whose saving moments are less than five minutes to the saving moment of the picture from remaining pictures under the picture directory, to obtain a next picture group until all pictures under the picture directory are divided into different picture groups.

In actual application, in addition to that pictures under the picture directory are divided into different picture groups according to a saving moment of each picture, pictures may be divided into different picture groups according to a photographing location, a pixel value, brightness, contrast, a grayscale, and the like. Certainly, the foregoing conditions may be randomly combined. That is, pictures in the picture directory may be divided according to at least two of the foregoing conditions. A specific combination thereof is not described in detail in this embodiment of the present disclosure.

(2) The terminal acquires a grayscale eigenvalue of each picture included in the each picture group according to a pixel value of the each picture included in the each picture group.

Refer to the following steps (a) to (e) for specific implementation of the process:

(a) The terminal reduces a size of each picture included in each picture group based on a pixel value of each picture included in each picture group until each picture includes a specified quantity of pixels.

In this embodiment, it is proper to reduce each picture in each picture group to a picture including 64 pixels. Details of each picture included in each picture group may be removed by reducing each picture in each picture group to a picture including 64 pixels, and basic information such as a structure and brightness of each picture included in each picture group is reserved, avoiding a picture difference brought by different sizes and different proportions.

(b) Simplify colors.

The pictures of which each picture is reduced to include 64 pixels are converted into grayscale pictures of 64 grayscales. That is, all pixel points of each picture included in each picture group have totally 64 colors.

(c) Calculate an average value of 64 grayscales.

For each picture included in the picture group, an average value of 64 grayscales of the picture is calculated,

(d) Compare grayscales of pixels to obtain a comparison result.

As regards each picture included in the picture group, each of 64 grayscales of the picture is compared with the average value of 64 grayscales. When any grayscale is greater than or equal to the average value of 64 grayscales, the comparison result is set to 1. When any grayscale is less than the average value of 64 grayscales, the comparison result is set to 0.

(e) Perform a Hash operation on all comparison results of each picture included in each picture group, to obtain a grayscale eigenvalue of each picture,

All comparison results of each picture included in each picture group are combined together, to form a 64-bit integer. The integer is a grayscale eigenvalue of the picture.

It should be noted that when all comparison results of each picture included in each picture group are combined together, an order of combination may be randomly set, as long as each picture is ensured to use a same order for combination. In addition, description is provided above by using an example in which each picture included in each picture group is reduced to a picture including 64 pixels. In actual application, each picture included in each picture group may be reduced to a picture including 36 pixels or 81 pixels.

(3) The terminal acquires a Hamming distance between grayscale eigenvalues of any two pictures within each picture group.

After acquiring grayscale eigenvalues of all pictures within each picture group, the terminal compares data on a same position of grayscale eigenvalues of any two pictures within each picture group to acquire alarming distance between grayscale eigenvalues of any two pictures within each picture group.

Specifically, a quantity of Limes for grayscale eigenvalues on a same position included in any two pictures to be different is acquired, and the quantity of times is used as a Hamming distance between grayscale eigenvalues of the any two pictures.

(4) If a Hamming distance between grayscale eigenvalues of any two pictures within each picture group is less than a preset value, the terminal uses any two pictures within each picture as similar pictures and composes all pictures that are similar pictures to a same picture within each picture group into a similar picture group.

The preset value may be 5, 7, 10, and so on. The preset value is not specifically limited in this embodiment. Using an example in which the preset value is 5, when a Hamming distance between grayscale eigenvalues of any two pictures within any picture group is less than 5, that is, a quantity of times for data on a same position of the two pictures to be different is less than 5, the two pictures in the picture group are regarded as similar pictures. When a Hamming distance between grayscale eigenvalues of any two pictures within any picture group is greater than 5, that is, a quantity of times for data on a same position of the two pictures to be different is greater than 5; the two pictures in the picture group are regarded as dissimilar pictures. When all pictures within a picture group are compared in the foregoing manner, a relationship between any two pictures within each picture group is basically determined. In this case, the terminal may compose all pictures that are similar pictures to a same picture within each picture group into a similar picture group. For example, a picture group has four pictures, namely, a picture A, a picture B, a picture C, and a picture D. If the picture A and the picture B are similar pictures, the picture B and the picture C are similar pictures, the picture A and the picture C are not similar pictures, the picture A and the picture D are not similar pictures, and the picture B and the picture D are not similar pictures, the picture A, the picture B, and the picture C are composed into a similar picture group.

When a picture group is acquired, the pictures are roughly divided only according to saving moments of the pictures. However, in actual application, a user may repeatedly photograph multiple contents within a time period or repeatedly capture multiple areas by using a screenshot tool. In this case, pictures divided into one picture group possibly have similar contents to those of pictures in a next picture group. Therefore, to improve accuracy of similar picture groups and avoiding missing any one possible picture in a similar picture group, if a Hamming distance between grayscale eigenvalues of any one picture and each of other pictures within a picture group is greater than the preset value, the picture is added to a next and/or previous picture group. The next picture group is a picture group whose saving moment is earliest to the picture group, and the previous picture group is a picture group whose saving moment is latest to the picture group.

The step of adding the picture to a next and/or previous picture group may be: selecting a latest saving moment from saving moments of pictures included in the previous picture group, selecting an earliest saving moment from saving moments of pictures included in the next picture group, calculating a first time difference between a saving moment of the picture and the latest saving moment, and calculating a second time difference between the saving moment of the picture and the earliest saving moment; if the first time difference is greater than the second time difference, adding the picture to the next picture group; if the first time difference is less than the second time difference, adding the picture to the previous picture group; and if the first time difference is equal to the second time difference, adding the picture to both the previous picture group and the next picture group.

303: The terminal acquires one representative picture from the each similar picture group according to attribute information of each picture included in the each similar picture group.

For each similar picture group, each similar picture group includes at least two pictures. When the user wants to select one picture from each similar picture group for saving, if pictures within the similar picture group are browsed one by one, a large amount of time of the user may be wasted. For this reason, in the method provided in this embodiment, one representative picture may further be acquired from each similar picture group according to attribute information of each picture of each similar picture group.

When the terminal acquires one representative picture from each similar picture group according to different contents in attribute information, the following manner may be used:

In one embodiment of the present disclosure, the attribute information may be a saving moment. A picture with an earliest saving moment is determined in each similar picture group according to a saving moment of each picture included each similar picture group, and the determined picture is used as a representative picture of a similar picture group in which the picture is.

Alternatively, a picture with a latest saving moment is determined in the each similar picture group according to a saving moment of each picture included in the each similar picture group, and the determined picture is used as a representative picture of a similar picture group in which the picture is.

For example, pictures in a similar picture group are a picture A, a picture B, and, a picture C. A saving moment of the picture A is Apr. 1, 2015, 8:00:00, a saving moment of the picture B is Apr. 1, 2015, 8:00:10, and a saving moment of the picture C is Apr. 1, 2015, 8:00:05, Pictures in a similar picture group are ordered according to saving moments from the latest to the earliest, to obtain the picture B, the picture C, and the picture A. According to an ordering result, the terminal may use the picture B as a representative picture of the similar picture group. Alternatively, the terminal may use the picture A as a representative picture of the similar picture group.

In another embodiment of the present disclosure, the attribute information may be a pixel value. A picture with a highest pixel value is determined in each similar picture group according to a pixel value of each picture included in each similar picture group, and the determined picture is used as a representative picture of a similar picture group in which the picture is. For example, pictures in the similar picture group are a picture A, and a picture B, and a picture C. A pixel value of the picture A is 2056, a pixel value of the picture B is 1024, and a pixel value of the picture C is 4059. Pictures in the similar picture group are ordered according to a descending manner of pixel values, to obtain the picture C, the picture A, and the picture B. The terminal may use the picture C as a representative picture of the similar picture group according to an ordering result.

Certainly, in addition to according to a saving moment or a pixel value, the terminal may acquire a representative picture from each similar picture group according to any combination of a saving moment, a pixel value, contrast, brightness, and the like, that is, the terminal may acquire one representative picture from each similar picture group according to at least two of the foregoing pieces of attribute information.

For example, a specific process in which the terminal acquires one representative picture from each similar picture group according to contrast and brightness may be:

For each picture included in each picture group, the terminal separately acquires a first weight corresponding to contrast and a second weight corresponding to brightness, calculates an attribute value of each picture according to a contrast value and a brightness value of each picture, the first weight and the second weight, and selects a picture with a greatest attribute value from each similar picture group as a representative picture of the similar picture group according to the attribute value of each picture.

The step of calculating an attribute value of each picture according to a contrast value and a brightness value of each picture, the first weight and the second weight may be:

For each picture, a product of the contrast value of the picture and the first weight is calculated to obtain a first value, a product of the brightness value of the picture and the second weight is calculated to obtain a second value, and a sum of the first value and the second value is calculated to be used as an attribute value of the picture.

304: The terminal displays a representative picture in the each similar picture group and pictures other than the representative picture in the each similar picture group with different markings when the at least one similar picture group is displayed.

For ease of distinguishing identified similar pictures, the terminal displays a representative picture in each similar picture group and pictures other than the representative picture in each similar picture group with different markings when at least one similar picture group is displayed. For example, the terminal displays pictures other than the representative picture in each similar picture group in a default display manner, displays the representative picture in each similar picture group in a clear display manner clearer than the default display manner, or displays the representative picture in each similar picture group in a blurry display manner blurrier than the default display manner. The terminal may perform differential display further by adding different identifiers to the representative picture in each similar picture group and pictures other than the representative picture. As shown in FIG. 5, the terminal may add an identifier 1 to the representative picture in each similar picture group, and add an identifier 2 to pictures other than the representative picture in each similar picture group.

305: The terminal processes a similar picture group in which the representative picture is by using different methods when different operations performed on the representative picture by the user are detected.

To help the user save the representative picture of each similar picture group, the terminal further displays a save option on the representative picture of each similar picture group. The save option may be in a menu form or in a button form. Forms of the save option are not specifically limited in this embodiment. The user may trigger the terminal to save the representative picture by selecting the save option.

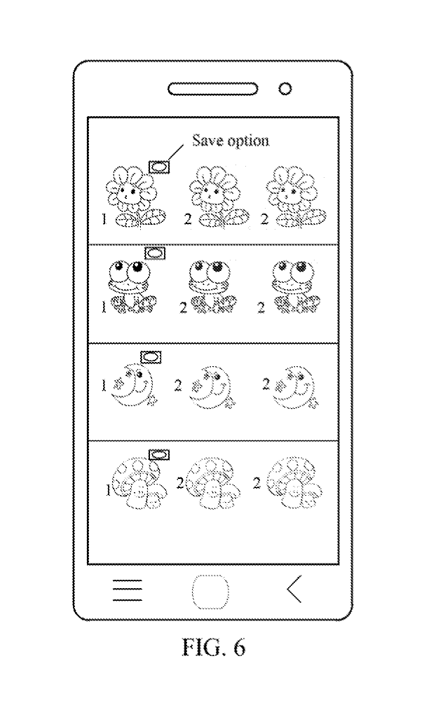

In one embodiment of the present disclosure, if it is detected that the save option on any representative picture is selected, the terminal saves the representative picture and deletes pictures other than the representative picture within the similar picture group in which the representative picture is. In this case, the similar picture group becomes a common picture, and the picture is not scanned when the terminal scans the similar picture group next time. Referring to FIG. 6, the terminal scans pictures under the picture directory and generates four similar picture groups according to attribute information of each picture After one representative picture is acquired from each similar picture group, the terminal adds an identifier 1 to the representative picture of each generated similar picture group, adds an identifier 2 to pictures other than the representative picture within the similar picture group, then exhibits the pictures to the user, and displays a save button on the representative picture of each similar picture group. When it is detected that any save button on four representative pictures is selected, the terminal saves the representative picture and deletes other pictures within the similar picture group in which the representative picture is.

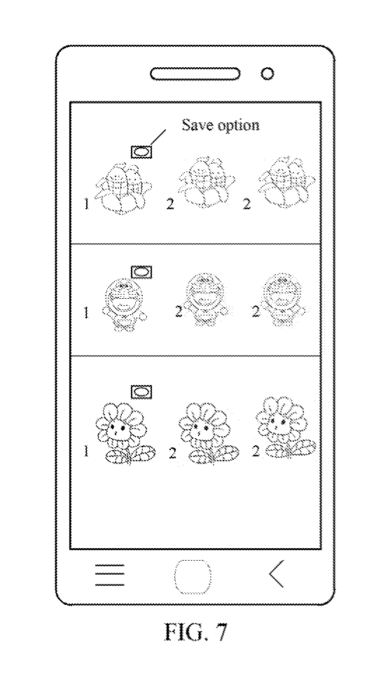

In another embodiment of the present disclosure, if a save option on any representative picture is not selected, the terminal saves all pictures in a separate similar picture group. When the terminal scans the similar picture group next time, the picture group is displayed after another newly added picture group. Referring to FIG. 7, if a similar picture group A is a similar picture group obtained by scanning, pictures under the picture directory last time, when pictures within the similar picture group are displayed last time, the terminal detects that a save option on a representative picture of the similar picture group A is selected, and the terminal saves all pictures within the similar picture group A. When the user triggers a similar picture processing option on a picture processing page this time, the terminal displays the similar picture group A after a similar picture group B and a similar picture group C that are newly added.

In the method provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

Referring to FIG. 8, an embodiment of the present disclosure provides a schematic structural diagram of a picture processing apparatus. The apparatus includes: a scanning module 801, configured to scan pictures under a picture directory; a generation module 802, configured to generate at least one similar picture group according to attribute information of each scanned picture, each similar picture group of the at least one similar picture group including at least two pictures, and the attribute information including at least a saving moment and a pixel value; an acquiring module 803, configured to acquire one representative picture from the each similar picture group according to attribute information of each picture included in the each similar picture group; and a first display module 804, configured to display a representative picture in the each similar picture group and pictures other than the representative picture in the each similar picture group with different markings when the at least one similar picture group is displayed.

In another embodiment of the present disclosure, the acquiring module 803 is configured to determine a picture with an earliest saving moment in the each similar picture group according to a saving moment of each picture included in the each similar picture group and use the determined picture as a representative picture of a similar picture group in which the picture is; the acquiring module 803 is configured to determine a picture with a latest saving moment in the each similar picture group according to a saving moment of each picture included in the each similar picture group and use the determined picture as a representative picture of a similar picture group in which the picture is; or the acquiring module 803 is configured to determine a picture with a highest pixel value in the each similar picture group according to a pixel value of each picture included in the each similar picture group and use the determined picture as a representative picture of a similar picture group in which the picture is.

In another embodiment of the present disclosure, the apparatus further includes: a second display module, configured to display a save option on the representative picture of the each similar picture group; and a processing module, configured to save the representative picture and delete other pictures within a similar picture group in which the representative picture is if it is detected that a save option on any representative picture is selected.

In another embodiment of the present disclosure, the generation module 802 is configured to: divide each scanned picture into at least one picture group according to a saving moment of the each scanned picture, where each picture group of the at least one picture group includes at least two pictures; acquire a grayscale eigenvalue of each picture included in the each picture group according to a pixel value of the each picture included in the each similar picture group; acquire a Hamming distance between grayscale eigenvalues of any two pictures within the each picture group according to a grayscale eigenvalue of each picture included in the each picture group; use any two pictures within the each picture group as similar pictures if the Hamming distance between the grayscale eigenvalues of the any two pictures within the each picture group is less than a preset value; and compose all pictures that ate similar pictures to a same picture within the each picture group into a similar picture group.

In another embodiment of the present disclosure, the apparatus further includes: a picture adding module, configured to, if Hamming distances between a grayscale eigenvalue of one picture within any picture group and grayscale eigenvalues of pictures other than the picture within the picture group are all greater than the preset value, add the picture to a next picture group and/or a previous picture group, where the next picture group is a picture group whose saving moment is earliest to the picture group, and the previous picture group is a picture group whose saving moment is latest to the picture group.

In the apparatus provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

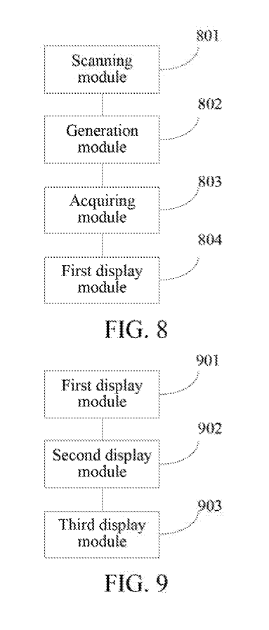

Referring to FIG. 9, an embodiment of the present disclosure provides a picture processing apparatus. The apparatus includes: a first display module 901, configured to display a picture processing page, the picture processing page including at least a similar picture cleanup option; a second display module 902, configured to display at least one similar picture group after a selection operation for the similar picture cleanup option is detected, the at least one similar picture group being generated according to attribute information of a picture stored locally, and the attribute information including at least a saving moment and a pixel value; and a third display module 903, configured to display a representative picture in each similar picture group of the at least one similar picture group and pictures other than the representative picture in the each similar picture group with different markings when the at least one similar picture group is displayed.

In another embodiment of the present disclosure, the apparatus further includes a first acquiring module, configured to acquire a representative picture of each similar picture group of the at least one similar picture group, where the representative picture of the each similar picture group is a picture with an earliest saving moment, a latest saving moment, or a highest pixel value in the each similar picture group.

In another embodiment of the present disclosure, the apparatus further includes: a fourth display module, configured to display a save option on the representative picture of the each similar picture group; and a deletion module, configured to save the representative picture and delete other pictures within a similar picture group in which the representative picture is after a selection operation for a save option on any representative picture is detected.

In another embodiment of the present disclosure, the apparatus further includes: a second acquiring module, configured to acquire at least one similar picture group, where the at least one similar picture group is composed of all pictures that are similar pictures to a same picture within each picture group obtained by performing division according to a saving moment of a picture stored locally, and the similar pictures are pictures that are within the picture group determined according to a pixel value and a Hamming distance between grayscale eigenvalues of which is less than a preset value.

In another embodiment of the present disclosure, the apparatus further includes: a picture adding module, configured to add a picture within any picture group to a next picture group, where the picture is a picture that is in the picture group and a Hamming distance between a grayscale eigenvalue of which and grayscale eigenvalues of pictures other than the picture in the picture group is greater than the preset value, and the next picture group is a picture group whose saving moment is earliest to the picture group.

In the apparatus provided in this embodiment of the present disclosure, a similar picture group is acquired according to attribute information of each picture, and a representative picture in each similar picture group and other pictures are displayed with different markings. The process can select a similar picture fur a user without participation of the user, and a saved picture recommended to the user is distinguished from other pictures for display, so that a checking process is more convenient and takes a shorter time.

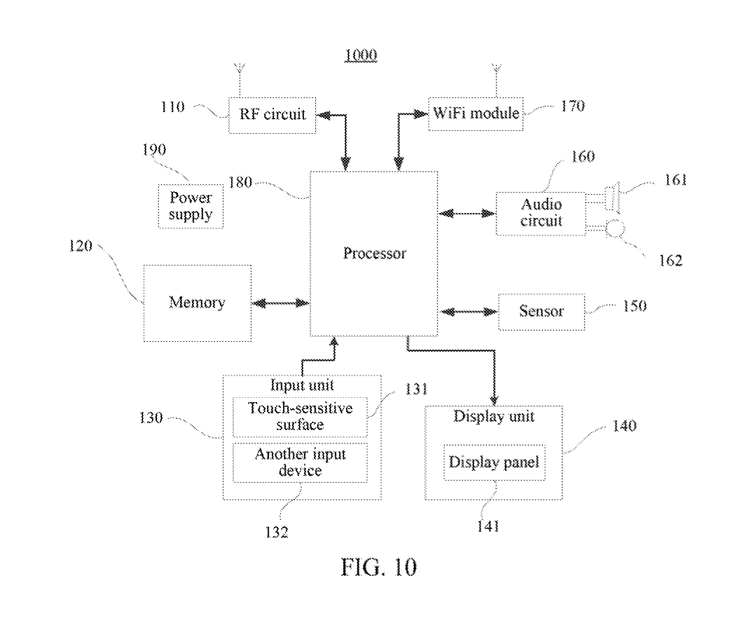

Referring to FIG. 10, FIG. 10 is a schematic structural diagram of a terminal involved in a picture processing, method according to an embodiment of the present disclosure. The terminal may be configured to implement the picture processing method provided in the foregoing embodiment. Specifically:

A terminal 1000 may include components such as an RF (Radio Frequency) circuit 110, a memory 120 including one or more computer readable storage media, an input unit 130, a display unit 140, a sensor 150, an audio circuit 160, a WiFi (Wireless Fidelity) module 170, a processor 180 including one or more processing cores, and a power supply 190. A person skilled in the art would understand that the terminal structure shown in FIG. 10 does not impose a limitation on the terminal and may include components more or less than those shown in the figure, or a combination of some components, or different component arrangements.

The RF circuit 110 may be configured to receive and send a signal. In an information receiving and sending process or a call process, and in particular, receive downlink information of a base station, then deliver the downlink information for one or more processors 180 to process, and send related uplink data to the base station. Usually, the RE circuit 110 includes, but is not limited to, an antenna, at least one amplifier, a tuner, one or more oscillators, a subscriber identity module (SIM) card, a transceiver, a coupler, an LNC (Low Noise Amplifier), a duplexer, and the like. In addition, the RF circuit 110 may communicate with a network and other devices by using wireless communication. The foregoing wireless communication may use any communications standard or protocol, which includes, but is not limited to, GSM (Global System for Mobile Communications), GPRS (General Packet Radio Service). CDMA (Code Division Multiple Access), WCDMA (Wideband Code Division Multiple Access), LTE (Long Term Evolution), e-mail, SMS (Short Messaging. Service), and the like.

The memory 120 may be configured to store software programs. The processor 180 executes various functional applications and data processing by running the software program and modules stored in the memory 120. The memory 120 may mainly include a program storage area and a data storage area, where the program storage area may stare an operating system, an application program (such as a voice playing function and an image playing function) required by at least one function, and the like; the data storage area may store data (such as audio data and a telephone book) created according to using of the terminal 1000 and the like. In addition, the memory 120 may include a high-speed random access memory and may further include a nonvolatile memory, for example, at least one magnetic disk storage device, a flash memory device, or other volatile solid storage devices. Accordingly, the memory 120 may further include a memory controller, so that the processor 180 and the input unit 130 access the memory 120. The various modules as described in FIGS. 1-9 may include software programs and date stored in memory 120 and the processor 180 so that when each module is executed, it can perform the as described functions.

The input unit 130 may be configured to receive input digit or character information, and generate keyboard, mouse, joystick, optical, or track ball signal input related to the user setting and function control. Specifically, the input unit 130 may include a touch-sensitive surface 131 and another input device 132 The touch-sensitive surface 131 may also be referred to as a touch display screen or a touch panel, and may collect a touch operation of a user on or near the touch-sensitive surface (such as an operation of a user on or near the touch-sensitive surface 131 by using any suitable object or attachment, such as a finger or a touch pen), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180, In addition, the touch-sensitive surface 131 may be implemented by using various types, such as a resistive type, a capacitance type, an infrared type, and a surface sound wave type. In addition to the touch-sensitive surface 131, the input unit 130 may further include the input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided fir the user, and various graphical user ports of the terminal 1000. The graphical user ports may be thrilled by a graph, a text, an icon, a video, and any combination thereof. The display unit 140 may include a display panel 141. Optionally, the display panel 141 may be configured by using a liquid crystal display (LCD), an organic light-emitting diode (OLED), or the like, Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 10, the touch-sensitive surface 131 and the display panel 141 are used as two separate parts to implement input and output functions, in some embodiments, the touch-sensitive surface 131 and the display panel 141 may be integrated to implement the input and output functions.

The terminal 1000 may further include at least one sensor 150, such as an optical sensor, a motion sensor, and other sensors, Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1000 is moved to the ear, As one type of motion sensor, a gravity acceleration sensor may detect magnitude of accelerations at various directions (which generally are tri-axial), may detect magnitude and a direction of the gravity when static, and may be configured to identify an application of a mobile phone gesture (such, as switchover between horizontal and vertical screens, a related game, and gesture calibration of a magnetometer), a related function of vibration identification (such as a pedometer and a knock). Other sensor, such, as a gyroscope, a barometer, a hygrometer, a thermometer, and an infrared sensor, which may be configured in the terminal 1000 are not further described herein.

The audio circuit 160, a loudspeaker 161, and a microphone 162 may provide audio interfaces between the user and the terminal 1000. The audio circuit 160 may transmit, to the loudspeaker 161, a received electric signal converted from received audio data. The loudspeaker 161 converts the electric signal into a sound signal for output. On the other band, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RE circuit 110, or outputs the audio data to the memory 120 for further processing. The audio circuit 160 may further include an earplug jack, so as to provide communication between a peripheral earphone and the terminal 1000.

WiFi belongs to a short distance wireless transmission technology. The terminal 1000 may help, by using a WiFi module 170, a user receive and send an e-mail, browse a webpage, and access stream media, and the like, which provides wireless broadband Internet access for the user. Although FIG. 10 shows the WiFi module 170, it may be understood that the WiFi module 170 does not belong to a necessary constitution of the terminal 1000, and can be ignored according to demands without changing the scope of the essence of the present disclosure.

The processor 180 is a control center of the terminal 1000, and connects to various parts of the mobile phone by using various interfaces and lines. By running or executing the software program and/or module stored in the memory 120, and invoking data stored in, the memory 120, the processor 180 performs various functions and data processing of the terminal 1000, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may also not be integrated into the processor 180.

The terminal 1000 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown in the figure, the terminal 1000 may further include a camera, a Bluetooth module, and the like, which are not further described herein. Specifically, in this embodiment, the display unit of the terminal 1000 is a touch screen display, and the terminal 1000 further includes a memory and one or more programs. The one or more programs are stored in the memory and configured to be executed by one or more processors. The one or more programs contain instructions used for implementing the following operations: scanning pictures under a picture directory; generating at least one similar picture group according to attribute information of each scanned picture, each similar picture group of the at least one similar picture group including at least two pictures, and the attribute information including at least a saving moment and a pixel value; acquiring one representative picture from the each similar picture group according to attribute information of each picture included in the each similar picture group; and displaying a representative picture in the each similar picture group and pictures other than the representative picture in the each similar picture group with different markings when the at least one similar picture group is displayed.

It is assumed that the foregoing content is a first possible implementation manner, and in a second possible implementation manner provided by using the first possible implementation manner as the basis, the memory of the terminal further contains instructions used for implementing the following operations: the acquiring one representative picture from the each similar picture group according to attribute information of each picture included in the each similar picture group. The acquiring step includes determining a picture with an earliest saving moment in the each similar picture group according to a saving moment of each picture included in the each similar picture group and using the determined picture as a representative picture of a similar picture group in which the picture is; determining a picture with a latest saving moment in the each similar picture group according to a saying moment of each picture included in the each similar picture group and using the determined picture as a representative picture of a similar picture group in which the picture is; or determining a picture with a highest pixel value in the each similar picture group according to a pixel value of each picture included in the each similar picture group and using the determined picture as a representative picture of a similar picture group in which the picture is.

It is assumed that the foregoing content is the second possible implementation manner, and in a third possible implementation manner provided by using the second possible implementation manner as the basis, the memory of the terminal further contains instructions used for implementing the following operations: after the displaying a representative picture in the each similar picture group and other pictures in the each similar picture group with different markings, further including: displaying a save option on the representative picture of the each similar picture group; and saving the representative picture and deleting other pictures within a similar picture group in which the representative picture is if it is detected that a save option on any representative picture is selected.

It is, assumed that the foregoing content is the third possible implementation manner, and in a fourth possible implementation manner provided by using the third possible implementation manner as the basis, the memory of the terminal further contains instructions used for implementing the following operations: the generating at least one similar picture group according to attribute information of each scanned picture including: dividing each scanned picture into at least one picture group according to a saving moment of the each scanned picture, where each picture group of the at least one picture group includes at least two pictures; acquiring a grayscale eigenvalue of each picture included in the each picture group according to a pixel value of the each picture included in the each picture group: acquiring a Hamming distance between grayscale eigenvalues of any two pictures within the each picture group according to a grayscale eigenvalue of each picture included in the each picture group; using any two pictures within the each picture group as similar pictures if the Hamming distance between the grayscale eigenvalues of the any two pictures within the each picture group is less than a preset value; and composing all pictures that are similar pictures to a same picture within the each picture group into a similar picture group.

It is assumed that the foregoing content is the fourth possible implementation manner, and in a fifth possible implementation manner provided by using the fourth possible implementation manner as the basis, the memory of the terminal further contains instructions used for implementing the following operations: if Hamming distances between a grayscale eigenvalue of one picture within any picture group and grayscale eigenvalues of pictures other than the picture within the picture group are all greater than the preset value, adding the picture to a next picture group and/or a previous picture group, where the next picture group is a picture group whose saving moment is earliest to the picture group, and the previous picture group is a picture group whose saving moment is latest to the picture group.

In the terminal provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

An embodiment of the present disclosure further provides a computer readable storage medium. The computer readable storage medium may be a computer readable storage medium included in the memory in the foregoing embodiment or may be a computer readable storage medium that exists alone and is not assembled into the terminal. The computer readable storage medium stores one or more programs, and the one or more programs are used by one or more processors to execute the picture processing method. The method includes in a second possible implementation manner provided by using a first possible implementation manner as the basis. The memory of the terminal further contains instructions used for implementing the following operations: scanning pictures under a picture directory; generating at least one similar picture group according to attribute information of each scanned picture, each similar picture group of the at least one similar picture group including at least two pictures, and the attribute information including at least a saving moment and a pixel value; acquiring one representative picture from the each similar picture group according to attribute information of each picture included in the each similar picture group; and displaying a representative picture in the each similar picture group and pictures other than the representative picture in the each similar picture group with different markings when the at least one similar picture group is displayed.

It is assumed that the foregoing content is the first possible implementation manner, and in a second possible implementation manner provided by using the first possible implementation manner as the basis, the memory of the terminal further contains instructions used for implementing the following operations: the acquiring one representative picture from the each similar picture group according to attribute information of each picture included in the each similar picture group. The acquiring step includes: determining a picture with an earliest saving moment in the each similar picture group according to a saving moment of each picture included in the each similar picture group and using the determined picture as a representative picture of a similar picture group in which the picture is: determining a picture with a latest saving moment in the each similar picture group according to a saving moment of each picture included in the each similar picture group and using the determined picture as a representative picture of a similar picture group in which the picture is; or determining a picture with a highest pixel value in the each similar picture group according to a pixel value of each picture included in the each similar picture group and using the determined picture as a representative picture of a similar picture group in which the picture is.

It is assumed that the foregoing content is the second possible implementation manner, and in a third possible implementation manner provided by using the second possible implementation manner as the basis, the memory of the terminal further contains instructions used for implementing the following operations: after the displaying a representative picture in the each similar picture group and other pictures in the each similar picture group with different markings, displaying a save option on the representative picture of the each similar picture group; and saving the representative picture and deleting other pictures within a similar picture group in which the representative picture is if it is detected that a save option on any representative picture is selected.

It is assumed that the foregoing content is the third possible implementation manner, and in a fourth possible implementation manner provided by using the third possible implementation manner as the basis, the memory of the terminal further contains instructions used for implementing the following operations: the generating at least one similar picture group according to attribute information of each scanned picture including dividing each scanned picture into at least one picture group according to a saving moment of the each scanned picture, where each picture group of the at least one picture group includes at least two pictures; acquiring a grayscale eigenvalue of each picture included in the each picture group according to a pixel value of the each picture included in the each picture group; acquiring a Hamming distance between grayscale eigenvalues of any two pictures within the each picture group according to a grayscale eigenvalue of each picture included in the each picture group; using any two pictures within the each picture group as similar pictures if the Hamming distance between the grayscale eigenvalues of the any two pictures within the each picture group is less than a preset value; and composing all pictures that are similar pictures to a same picture within the each picture group into a similar picture group.

It is assumed that the foregoing content is the fourth possible implementation manner, and in a fifth possible implementation manner provided by using the fourth possible implementation manner as the basis, the memory of the terminal further contains instructions used for implementing the following operations: if Hamming distances between a grayscale eigenvalue of one picture within any picture group and grayscale eigenvalues of pictures other than the picture within the picture group are all greater than the preset value, adding the picture to a next picture group and/or a previous picture group, where the next picture group is a picture group whose saving moment is earliest to the picture group, and the previous picture group is a picture group whose saving moment is latest to the picture group.

In the computer readable storage medium provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

An embodiment of the present disclosure provides a graphical user port. The graphical user port is used on a picture processing terminal, and the terminal for executing picture processing includes a touch screen display, a memory, and one or more processors used for executing one or more programs. The graphical user port includes: scanning pictures under a picture directory; generating at least one similar picture group according to attribute information of each scanned picture, each similar picture group of the at least one similar picture group including at least two pictures, and the attribute information including at least a saving moment and a pixel value; acquiring one representative picture from the each similar picture group according to attribute information of each picture included in the each similar picture group; and displaying a representative picture in the each similar picture group and pictures other than the representative picture in the each similar picture group with different markings when the at least one similar picture group is displayed.

In the graphical user port provided in this embodiment of the present disclosure, a similar picture group is acquired according to attribute information of each picture, and a representative picture in each similar picture group and other pictures are displayed with different markings. The process can select a similar picture for a user without participation of the user, and a saved picture recommended to the user is distinguished from other pictures for display, so that a checking process is more convenient and takes a shorter time.

It should be noted that when the picture processing apparatus processes pictures, the foregoing embodiment is merely described by using an example of dividing various functional modules. In actual application, the foregoing function allocation is completed by different functional modules according to needs, that is, the internal structure of the picture processing apparatus is divided into different functional modules, to complete all or a part of functions of the foregoing scanning. In addition, the picture processing apparatus provided in the foregoing embodiment belongs to the same idea as the picture processing method. See method embodiments for a specific implementation process thereof, and the details are not described herein again.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The above descriptions are merely preferred embodiments of the present disclosure and are used to limit the present disclosure. Any alternation, equivalent replacement, improvement, and the like made within the spirit and principle of the present disclosure should all be included within a protection scope of the present disclosure.

What is claimed is:

1. A picture processing method, the method comprising:
scanning pictures under a picture directory;
generating at least one similar picture group according to attribute information of each scanned picture, each similar picture group of the at least one similar picture group comprising at least two pictures, and the attribute information comprising at least a saving moment and a pixel value;
acquiring one representative picture from the each similar picture group according to attribute information of each picture in the each similar picture group; and
displaying a representative picture in the each similar picture group and pictures other than the representative picture in the each similar picture group with different markings when the at least one similar picture group is displayed.

2. The method according to claim 1, wherein the acquiring one representative picture from the each similar picture group according to attribute information of each picture in the each similar picture group comprises:
determining a picture with an earliest saving moment in the each similar picture group according to a saving moment of each picture in the each similar picture group and using the determined picture as a representative picture of a similar picture group in which the picture is
determining a picture with a latest saving moment in the each similar picture group according to a saving moment of each picture in the each similar picture group and using the determined picture as a representative picture of a similar picture group in which the picture is; or
determining a picture with a highest pixel value in the each similar picture group according to a pixel value of each picture in the each similar picture group and using the determined picture as a representative picture of a similar picture group in which the picture is.

3. The method according to claim 1, after the displaying a representative picture in the each similar picture group and pictures other than the representative picture in the each similar picture group with different markings, further comprising:
displaying a save option on the representative picture of the each similar picture group; and
saving the representative picture and deleting other pictures within a similar picture group in which the representative picture is if it is detected that a save option on any representative picture is selected.

4. The method according to claim 1, wherein the generating at least one similar picture group according to attribute information of each scanned picture comprises:
dividing each scanned picture into at least one picture group according to a saving moment of the each scanned picture, wherein each picture group of the at least one picture group comprises at least two pictures;
acquiring a grayscale eigenvalue of each picture in the each picture group according to a pixel value of the each picture in the each picture group;
acquiring a Hamming distance between grayscale eigenvalues of any two pictures within the each picture group according to a grayscale eigenvalue of each picture in the each picture group;
using any two pictures within the each picture group as similar pictures if the Hamming distance between the grayscale eigenvalues of the any two pictures within the each picture group is less than a preset value; and
composing all pictures that are similar pictures to a same picture within the each picture group into a similar picture group.

5. The method according to claim 4, the method further comprising:
if Hamming distances between a grayscale eigenvalue of one picture within any picture group and grayscale eigenvalues of pictures other than the picture within the picture group are all greater than the preset value, adding the picture to a next picture group and/or a previous picture group, wherein the next picture group is a picture group whose saving moment is earliest to the picture group, and the previous picture group is a picture group whose saving moment is latest to the picture group.

6. A picture processing method, the method comprising:
displaying a picture processing page, the picture processing page comprising at least a similar picture cleanup option;
displaying at least one similar picture group after a selection operation for the similar picture cleanup option is detected, the at least one similar picture group being generated according to attribute information of a picture stored locally and the attribute information comprising at least a saving moment and a pixel value; and
displaying a representative picture in each similar picture group of the at least one similar picture group and pictures other than the representative picture in the each similar picture group with different markings when the at least one similar picture group is displayed.

7. The method according to claim 6, before the displaying a representative picture in each similar picture group of the at least one similar picture group and pictures other than the representative picture in the each similar picture group with different markings, further comprising:
acquiring a representative picture of each similar picture group of the at least one similar picture group, wherein the representative picture of the each similar picture group is a picture with an earliest saving moment, a latest saving moment, or a highest pixel value in the each similar picture group.

8. The method according to claim 6, before the displaying a representative picture in each similar picture group of the at least one similar picture group and pictures other than the representative picture in the each similar picture group with different markings, further comprising:
displaying a save option on the representative picture of the each similar picture group; and
saving the representative picture and deleting other pictures within a similar picture group in which the representative picture is after a selection operation for a save option on any representative picture is detected.

9. The method according to claim 6, before the displaying at least one similar picture group, further comprising:
acquiring at least one similar picture group, wherein the at least one similar picture group is composed of all pictures that are similar pictures to a same picture within, each picture group obtained by performing division according to a saving moment of a picture stored locally, and the similar pictures are pictures that are within the picture group determined according to a pixel value and a Hamming distance between grayscale eigenvalues of which is less than a preset value.

10. The method according to claim 9, the method further comprising:
adding a picture within any picture group to a next picture group, wherein the picture is a picture that is in the picture group and a Hamming distance between a grayscale eigenvalue of which and grayscale eigenvalues of pictures other than the picture in the picture group is greater than the preset value, and the next picture group is a picture group whose saving moment is earliest to the picture group.

11. A picture processing apparatus, the apparatus comprising:
a scanning module, configured to scan pictures under a picture directory;
a generation module, configured to generate at least one similar picture group according to attribute information of each scanned picture, each similar picture group of the at least one similar picture group comprising at least two pictures, and the attribute information comprising at least a saving moment and a pixel value;
an acquiring module, configured to acquire one representative picture from the each similar picture group according to attribute information of each picture in the each similar picture group; and
a first display module, configured to display a representative picture in the each similar picture group and pictures other than the representative picture in the each similar picture group with different markings when the at least one similar picture group is displayed.

12. The apparatus according to claim 11, wherein the acquiring module is configured to determine a picture with an earliest saving moment in the each similar picture group according to a saving moment of each picture in the each similar picture group and use the determined picture as a representative picture of a similar picture group in which the, picture is; the acquiring module is configured to determine a picture with a latest saving moment in the each similar picture group according to a saving moment of each picture in the each similar picture group and use the determined picture as a representative picture of a similar picture group in which the picture or the acquiring module is configured to determine a picture with a highest pixel value in the each similar picture group according to a pixel value of each picture in the each similar picture group and use the determined picture as a representative picture of a similar picture group in which the picture is.

13. The apparatus according to claim 11, the apparatus further comprising:
a second display module, configured to display a save option on the representative picture of the each similar picture group; and
a processing module, configured to save the representative picture and delete other pictures within a similar picture group in which the representative picture is if it is detected that a save option on any representative picture is selected.

14. The apparatus according to claim 11, wherein the generation module is configured to:
divide each scanned picture into at least one picture group according to a saving moment of the each scanned picture, wherein each picture group of the at least one picture group comprises at least two pictures; acquire a grayscale eigenvalue of each picture in the each picture group according to a pixel value of the each picture in the each picture group; acquire a Hamming distance between grayscale eigenvalues of any two pictures within the each picture group according to a grayscale eigenvalue of each picture in the each picture group; use any two pictures within the each picture group as similar pictures if the Hamming distance between the grayscale eigenvalues of the any two pictures within the each picture group is less than a preset value; and compose all pictures that are similar pictures to a same picture within the each picture group into a similar picture group.

15. The apparatus according to claim 14, the apparatus further comprising:
a picture adding module, configured to if Hamming distances between a grayscale eigenvalue of one picture within any picture group and grayscale eigenvalues of pictures other than the picture within the picture group are all greater than the preset value, add the picture to a next picture group and/or a previous picture group, wherein the next picture group is a picture group whose saving moment is earliest to the picture group, and the previous picture group is a picture group whose saving moment is latest to the picture group.

16. A picture processing apparatus, the apparatus comprising;
a first display module, configured to display a picture processing page, the picture processing page comprising at least a similar picture cleanup option;
a second display module, configured to display at least one similar picture group after a selection operation for the similar picture cleanup option is detected, the at least one similar picture group being generated according to attribute information of a picture stored locally, and the attribute information comprising at least a saving moment and a pixel value; and
a third display module, configured to display a representative picture in each similar picture group of the at least one similar picture group and pictures other than the representative picture in the each similar picture group with different markings when the at least one similar picture group is displayed.

17. The apparatus according to claim 16, the apparatus further comprising:
a first acquiring module, configured to acquire a representative picture of each similar picture group of the at least one similar picture group, wherein the representative picture of the each similar picture group is a picture with an earliest saving moment, a latest saving moment, or a highest pixel value in the each similar picture group.

18. The apparatus according to claim 16, the apparatus further comprising:
a fourth display module, configured to display a save option tin the representative picture of the each similar picture group; and
a deletion module, configured to save the representative picture and delete other pictures within a similar picture group in which the representative picture is after a selection operation for a save option on any representative picture is detected.

19. The apparatus according to claim 16, the apparatus further comprising:
a second acquiring module, configured to acquire at least one similar picture group, wherein the at least one similar picture group is composed of all pictures that are similar pictures to a same picture within each picture group obtained by performing division according to a saving moment of a picture stored locally, and the similar pictures are pictures that are within the picture group determined according to a pixel value and a Hamming distance between grayscale eigenvalues of which is less than a preset value.

20. The apparatus according to claim 19, the apparatus further comprising:
a picture adding module, configured to add a picture within any picture group to a next picture group, wherein the picture is a picture that is in the picture group and a Hamming distance between a grayscale eigenvalue of which and grayscale eigenvalues of pictures other than the picture in the picture group is greater than the preset value, and the next picture group is a picture group whose saving moment is earliest to the picture group.
